(19) United States
(12) Patent Application Publication
(10) Pub. No.: US 2017/0073070 A1
(43) Pub. Date: Mar. 16, 2017

(54) Amphibious vertical takeoff and landing unmanned device with artificial intelligence (AI) and method and system for managing a crisis environment and controlling one or more targets

(71) Applicant: Zhou Tian Xing, Tiburon, CA (US)

(72) Inventor: Zhou Tian Xing, Tiburon, CA (US)

(21) Appl. No.: 15/362,118

(22) Filed: Nov. 28, 2016

Related U.S. Application Data
(63) Continuation-in-part of application No. 29/572,722, filed on Jul. 29, 2016.
Application No. 29/572,722 is a continuation-in-part of application No. 29/567,712, filed on Jun. 10, 2016.
Application No. 29/567,712 is a continuation-in-part of application No. 14/940,379, filed on Nov. 13, 2015, now Pat. No. 9,493,235.
Application No. 14/940,379 is a continuation-in-part of application No. 14/957,644, filed on Dec. 3, 2015, now Pat. No. 9,489,671.
Application No. 14/957,644 is a continuation-in-part of application No. 14/815,988, filed on Aug. 1, 2015, now Pat. No. 9,342,829.
Application No. 14/815,988 is a continuation-in-part of application No. 13/760,214, filed on Feb. 6, 2013, now Pat. No. 9,016,565.

(51) Int. Cl. B64C 39/02; B64D 7/00; G05D 1/00; B60F 5/02; B60F 3/00; B64D 47/08

(52) U.S. Cl. CPC B64C 39/024; B60F 3/0061; B64D 47/08; G05D 1/0088; B60F 5/02; B64D 7/00; B64C 2203/00; B64D 2211/00; B64C 2201/024; B64C 2201/021; B64C 2201/042; B64C 2201/066; B64C 2201/141; B64C 2201/127; B64C 2201/12

(57) ABSTRACT

An amphibious vertical takeoff and landing unmanned device with artificial intelligence (AI) system and method for managing a crisis environment and controlling one or more targets through an unmanned aerial vehicle (UAV). The device includes a camera unit and a first plurality of tranquilizer guns. The camera unit captures an image of one or more targets. The first communication unit integrated with the camera unit to receive the image of the target. The GPS unit configured with the first communication unit to track geographical location of the one or more targets, and further tracks the itinerary of the unmanned aerial vehicle. The crisis detection unit to analyze the crisis environment. The first plurality of tranquilizer guns to receive the analyzed data from the crisis detection unit and initiates an action in order to sedate one or more targets.

### RELATED PATENT APPLICATION AND INCORPORATION BY REFERENCE

This is a utility application and is a continuation in part of application Ser. No. 15/345,308 Confirmation Number 6610 titled “An amphibious vertical take off and landing unmanned device with AI data processing apparatus” filed Nov. 7, 2016;

This application is a continuation-in-part of U.S. application Ser. No. 29/572/722, entitled “Amphibious vtol, hover, backward, leftward, rightward, turbojet, turbofan, rocket engine, ramjet, pulse jet, afterburner, and scramjet single/dual all in one jet engine (fuel/electricity) with onboard self computer based autonomous module gimbaled swivel propulsion (GSP) system device, same as ducted fan(fuel/electricity)”, filed Jul. 29, 2016.

This application is a continuation-in-part of U.S. application Ser. No. 29/567,712, entitled “Amphibious vtol, hover, backward, leftward, rightward, turbojet, turbofan, rocket engine, ramjet, pulse jet, afterburner, and scramjet all in one jet engine (fuel/electricity) with onboard self computer based autonomous gimbaled swivel propulsion system device” filed Jun. 10, 2016.

This application is a continuation-in-part of U.S. application Ser. No. 14/940,379, entitled “AMPHIBIOUS VERTICAL TAKEOFF AND LANDING UNMANNED SYSTEM AND FLYING CAR WITH MULTIPLE AERIAL AND AQUATIC FLIGHT MODES FOR CAPTURING PANORAMIC VIRTUAL REALITY VIEWS, INTERACTIVE VIDEO AND TRANSPORTATION WITH MOBILE AND WEARABLE APPLICATION” filed Nov. 13, 2015.

This application is a continuation-in-part of U.S. application Ser. No. 14/957,644 (publication no. 2016/0086,161), entitled “SYSTEMS AND METHODS FOR MOBILE APPLICATION, WEARABLE APPLICATION, TRANSACTIONAL MESSAGING, CALLING, DIGITAL MULTIMEDIA CAPTURE AND PAYMENT TRANSACTIONS”, filed Dec. 3, 2015; which is continuation-in-part of U.S. patent application Ser. No. 14/815,988 (publication no. 2015/0371,215), entitled “SYSTEMS AND METHODS FOR MOBILE APPLICATION, WEARABLE APPLICATION, TRANSACTIONAL MESSAGING, CALLING, DIGITAL MULTIMEDIA CAPTURE AND PAYMENT TRANSACTIONS” filed Aug. 1, 2015; which is continuation-in-part of Ser. No. 13/760,214 filed Feb. 6, 2013, which in turn is a continuation-in-part of Ser. No. 10/677,098 which claims priority to Provisional Application Ser. No. 60/415,546, filed on Oct. 1, 2002, the content of which is incorporated herein by reference in its entirety.

Moreover, the inventor(s) incorporate herein by reference any and all patents, patent applications, and other documents hard copy or electronic, cited or referred to in this application.

### COPYRIGHT AND TRADEMARK NOTICE

This application includes material which is subject or may be subject to copyright and/or trademark protection. The copyright and trademark owner(s) has no objection to the facsimile reproduction by any of the patent disclosure, as it appears in the Patent and Trademark Office files or records, but otherwise reserves all copyright and trademark rights whatsoever.

### TECHNICAL FIELD

The presently disclosed embodiments are related, in general, to an apparatus that corresponds to an unmanned aerial vehicle (UAV). More particularly, the presently disclosed embodiments are related to UAVs for managing a crisis environment and controlling one or more targets.

### BACKGROUND

Traditionally available unmanned aerial vehicle (UAV) able to stay in the air for much longer as it is not constrained by a human's physical limits. Existing UAVs may perform precise, repetitive and hard tasks over a long period which would be too hard, repetitively boring or need to much precision for an on-board pilot to perform. The aforementioned UAVs do not put the operator in danger so may fly in extreme and hostile climates as the operator may be stationed the other side of the world. Due to current uncertain social environment, it has become imperative to step up the development of unmanned aerial vehicle (UAV), protected remote control vehicle and robotics in aircraft.

Thus, there is a need in the art for methods and systems for managing a crisis environment and controlling one or more target through an unmanned aerial vehicle.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY

According to embodiments illustrated herein, there may be provided an unmanned aerial vehicle (UAV) for managing a crisis environment and controlling one or more target. The UAV includes a camera unit, a first communication unit, a GPS unit, a crisis detection unit, and a first plurality of tranquilizer gun. The camera unit captures an image of one or more target. The first communication unit integrated with the camera unit to receive the image of the target. The GPS unit configured with the first communication unit to track geographical location of the one or more target, and further tracks the itinerary of the unmanned aerial vehicle. The crisis detection unit to analyze the crisis environment. The first plurality of tranquilizer guns to receive the analyzed data from the crisis detection unit and initiates an action in order to sedate one or more target. The crisis detection unit includes a processing unit, a sensor unit, and a second communication unit. The processing unit to control the movement of the unmanned aerial vehicle based on the received geographical location data of the target and itinerary data from the GPS unit. The sensor unit having pre-stored instructions to sense the threat pertaining to the captured one or more target, and further the sensor unit programmed in order to initiate at least one of: a semi-autonomous decision, and an autonomous decision. The second communication unit to communicate the sensed data received from the sensor unit.

### BRIEF DESCRIPTION OF THE DRAWINGS

The accompanying drawings illustrate the various embodiments of systems, methods, and other aspects of the disclosure. Any person with ordinary skills in the art will appreciate that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa. Further, the elements may not be drawn to scale.

Various embodiments will hereinafter be described in accordance with the appended drawings, which are provided to illustrate and not to limit the scope in any manner, wherein similar designations denote similar elements, and in which:

FIGS. 1a-1c are illustrating an unmanned aerial vehicle (UAV) for managing a crisis environment and controlling one or more targets, in accordance with at least one embodiment;

FIGS. 2a-2e are exemplary operational views of a first unmanned aerial vehicle (UAV) for managing a crisis environment and controlling one or more targets, in accordance with at least one embodiment;

FIGS. 3a-3b are illustrating a fuselage having a forward cockpit to house a second plurality of tranquilizers, in accordance with at least one embodiment;

FIGS. 3c-3d are exemplary operational views of a second unmanned aerial vehicle (UAV) for managing a crisis environment and controlling one or more targets, in accordance with at least one embodiment; and

FIG. 4 is a flowchart that illustrates a method for managing a crisis environment and controlling one or more targets through an unmanned aerial vehicle (UAV), in accordance with at least one embodiment.

### DETAILED DESCRIPTION OF EMBODIMENTS OF THE INVENTION

The present disclosure may be best understood with reference to the detailed figures and description set forth herein. Various embodiments are discussed below with reference to the figures. However, those skilled in the art will readily appreciate that the detailed descriptions given herein with respect to the figures are simply for explanatory purposes as the apparatuses, methods and systems may extend beyond the described embodiments. For example, the teachings presented and the needs of a particular application may yield multiple alternative and suitable approaches to implement the functionality of any detail described herein. Therefore, any approach may extend beyond the particular implementation choices in the following embodiments described and shown.

References to “one embodiment,” “at least one embodiment,” “an embodiment,” “one example,” “an example,” “for example,” and so on indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” does not necessarily refer to the same embodiment.

Unless otherwise noted in this specification or in the claims, all of the terms used in the specification and the claims will have the meanings normally ascribed to these terms by workers in the art.

Unless the context clearly requires otherwise, throughout the description and the claims, the words “comprise,” “comprising” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “above,” “below,” and words of similar import, when used in this application, shall refer to this application as a whole and not to any particular portions of this application.

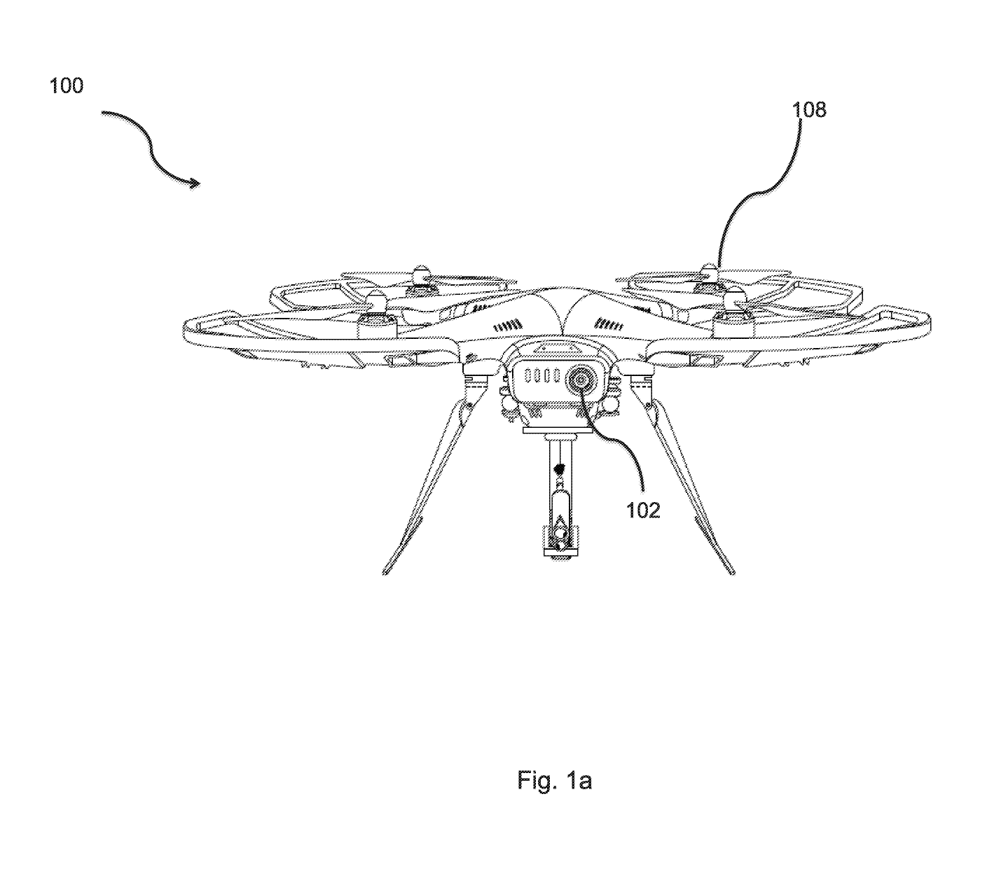

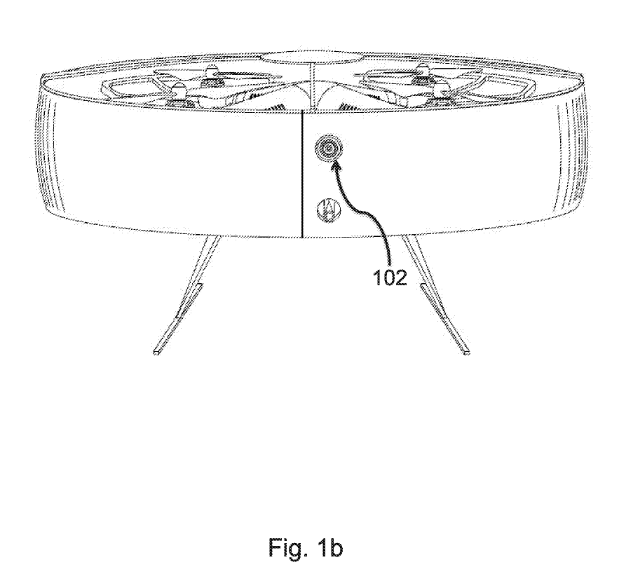

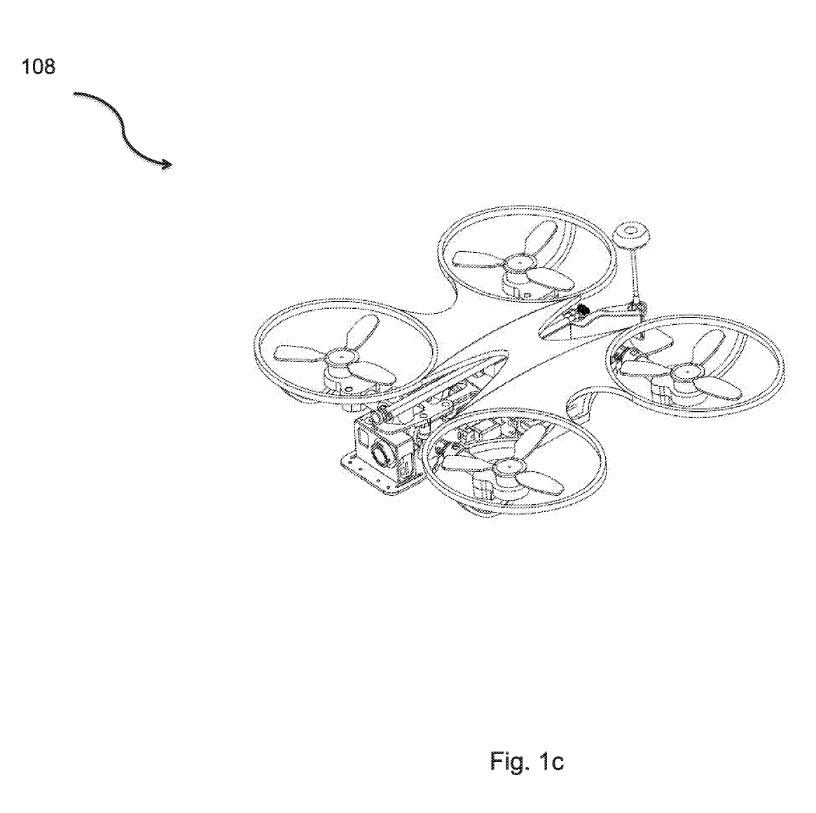

FIG. 1 is illustrates an unmanned aerial vehicle (UAV) 100 for managing a crisis environment and controlling one or more target, in accordance with at least one embodiment. As shown in FIG. 1, by way of example but not limitation, schematic diagram of the unmanned aerial vehicle (UAV) for managing a crisis environment and controlling one or more target may include at least one UAV or at least one remotely controlled UAV.

For certain example embodiments, a UAV 100 may comprise or include a vehicle that is not capable of being occupied by a human pilot (e.g., due to size, shape, power, atmospheric pressure, or a combination thereof, etc. constraints), a vehicle that is not designed to seat or otherwise safely support a person, a vehicle that is not controllable by an onboard human pilot, a vehicle that is being autonomously controlled at least partially by at least one onboard module, a vehicle that is being autonomously controlled at least partially by at least one off-board module, a combination thereof, or so forth. For certain example embodiments, a UAV 100 may be at least comparable to or may comprise or include at least a portion of any one or more of: an unoccupied flying vehicle (UFV), a remotely piloted vehicle (RPV), an unmanned combat air vehicle (UCAV), an unmanned aircraft (UA), a drone, an optionally-piloted vehicle (OPV) that is not currently being controlled by an on-board pilot, a remotely piloted aircraft (RPA), a remotely operated aircraft (ROA), a radio-controlled aircraft (R/C aircraft), an unmanned-aircraft vehicle system (UAVS), an unmanned aircraft system (UAS), a small unmanned air system (sUAS), a combination thereof, or so forth. For certain example embodiments, a UAV 100 may fly through a fluid (e.g., the earth's atmosphere or the air), through at least a partial vacuum (e.g., space or near-earth orbit), a combination thereof, or so forth. However, claimed subject matter is not limited to any particular described embodiments, implementations, examples, etc.

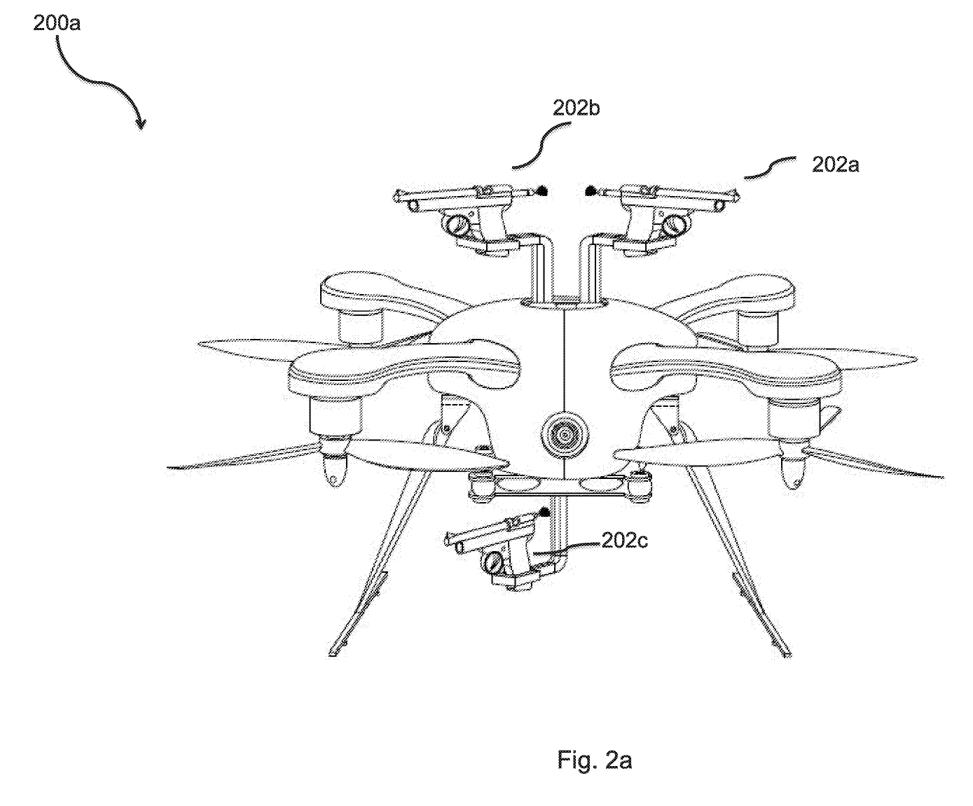

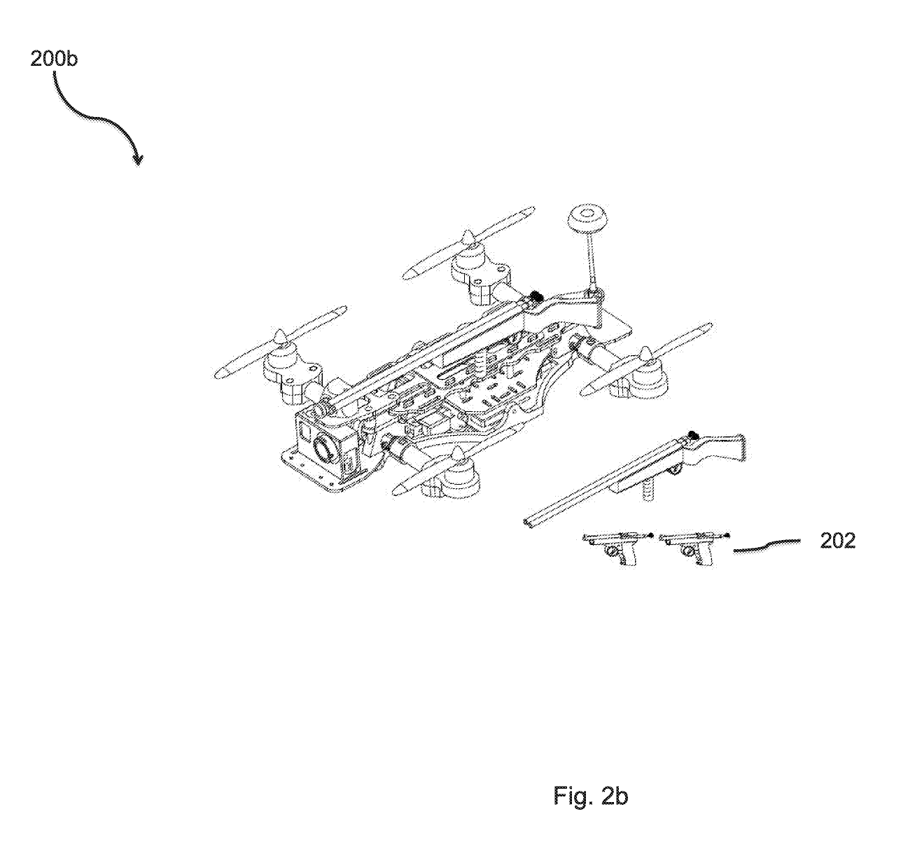

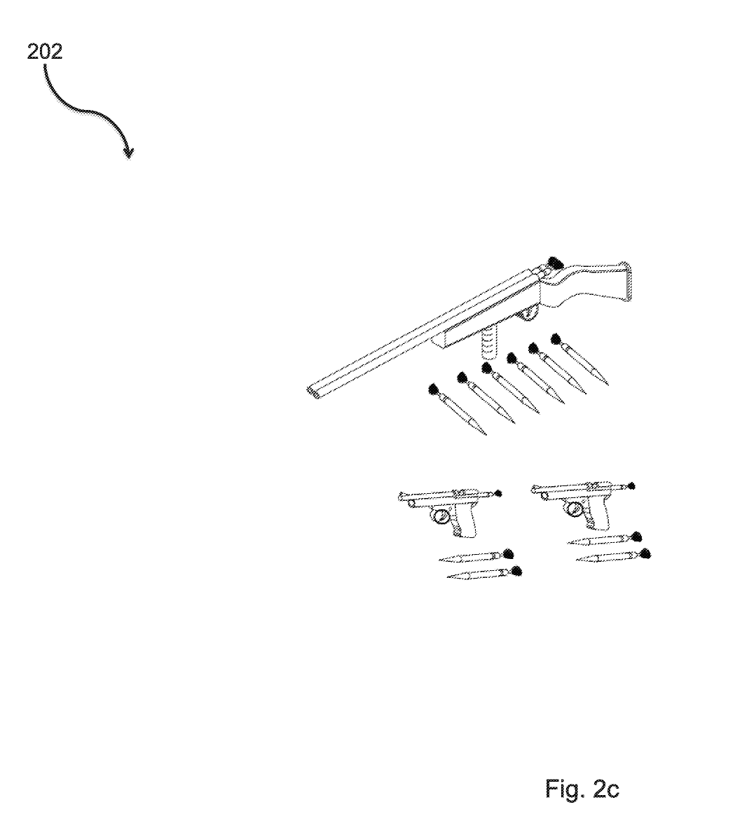

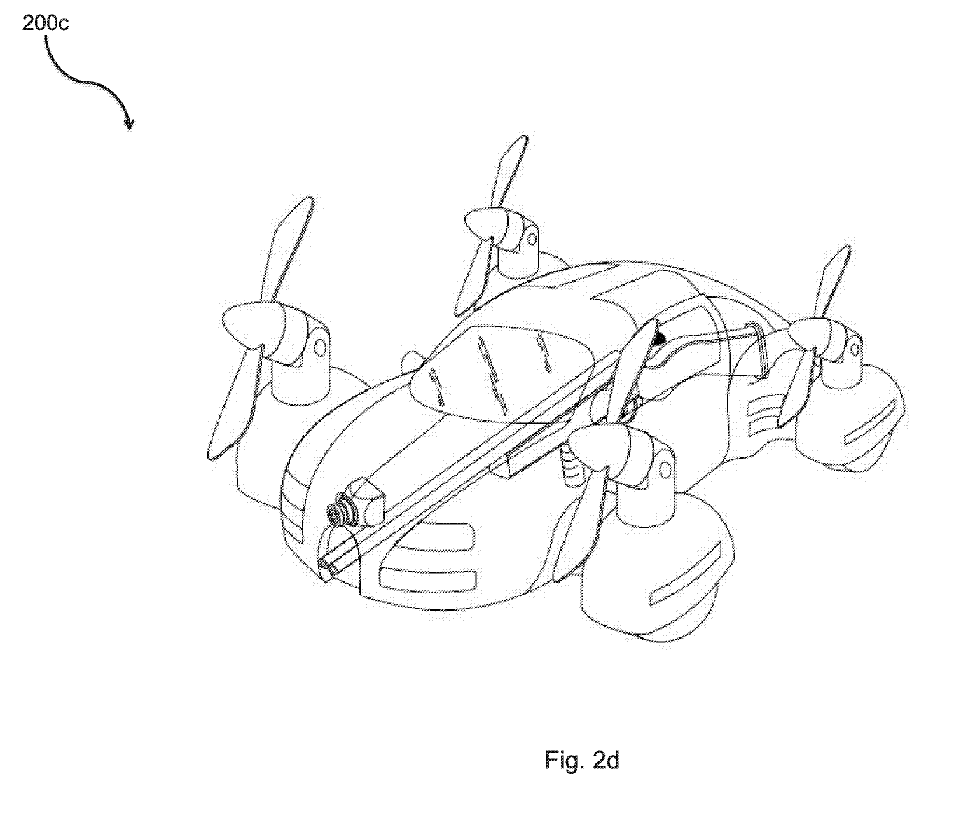

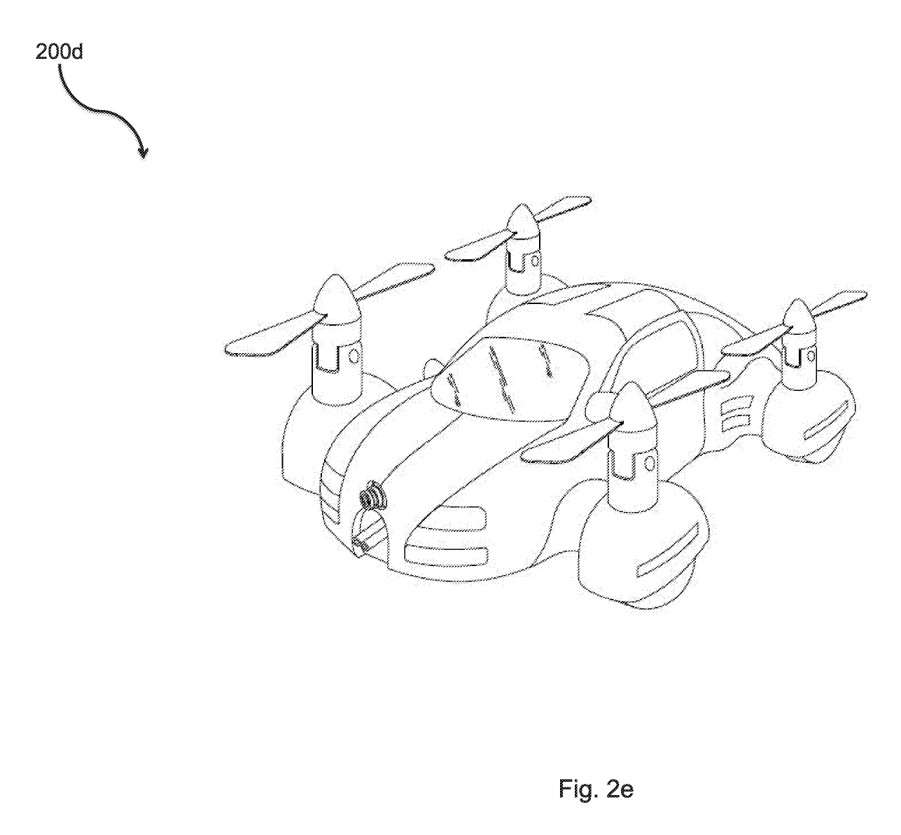

As shown in FIGS. 1a-1c the UAV 100 includes a camera unit 102, a first communication unit (not shown in FIG. 1), a GPS unit (not shown in FIG. 1), a crisis detection unit (not shown in FIG. 1), a first plurality of tranquilizer gun (shown and explained in conjunction with FIG. 2), and plurality of fans 108. The camera unit 102 captures a real-time video of the target, a real-time image of the target, and 360-degree panoramic video recording of the target used for virtual reality view. The camera unit 102 is further configured to adjust one or more of the parameters such as zoom, shutter speed, aperture, ISO, focal length, depth of field, exposure compensation, white balance, video or photo frame size and orientation, camera resolution and frame rates.

The first communication unit integrated with the camera unit 102 to receive the captured data of the target, and further performs high definition low latency real time data downlink. The first communication unit is a high power, high gain, and ultra-high frequency electronic device. The GPS unit configured with the first communication unit to track geographical location of the one or more target, and further tracks the itinerary of the unmanned aerial vehicle 100. The crisis detection unit to analyze the crisis environment. The crisis detection unit includes a processing unit, a sensor unit, and a second communication unit. The processing unit to control the movement of the unmanned aerial vehicle based on the received geographical location data of the target and itinerary data from the GPS unit.

The processing unit includes a flight controlling module to perform stable transitions between a hover mode, a full forward flight mode, and an underwater mode. The flight controlling module is selected from at least one an external micro controller or an internal micro controller; and a barometer, an accelerometer; a gyroscope, and a magnetometer. Further, the flight controlling module enables or disables the GPS unit, records flight parameters, allow inverted flight, aerial and aquatic rolls and flips, stabilize proportional, activates the UAV after user inputs an arming action or an arming sequence.

The GPS unit enables autonomous flying at low altitude and avoiding obstacles. The GPS unit further evaluates and selects landing sites in an unmapped terrain. Additionally, the GPS unit detects high-tension wires over a desert terrain.

In an embodiment, a navigation sensing unit configured with the GPS unit to map an unknown area where obstructions limited landing sites. The navigation sensing unit includes an inertial sensor to look forward and a laser scanner to look down. Additionally, the navigation sensing unit aborts paths to enable responding to unexpected circumstances.

The sensor unit having pre-stored instructions to sense the threat pertaining to the captured one or more target, and further the sensor unit programmed in order to initiate at least one of: a semi-autonomous decision, and an autonomous decision. The second communication unit to communicate the sensed data received from the sensor unit. Examples of the sensor unit includes but not limited to stereo sensors, ultrasonic sensors, infrared sensors, multispectral sensors, optical flow sensors, and volatile organic compound sensors. The aforementioned sensors are provided for intelligent positioning, collision avoidance, media capturing, surveillance, and monitoring.

In an exemplary implementation, the unmanned aerial vehicle 100 further includes a memory unit to store the geographical location data pertaining to the target, itinerary data of the unmanned aerial vehicle, and decision data. The unmanned aerial vehicle 100 further includes a notification unit to receive the sensed data from the second communication unit to notify one or more authority.

The unmanned aerial vehicle 100 further includes a speaker unit to announce a pre-recorded message in order to initiate a voice command. The unmanned aerial vehicle 100 is operated by a remote unit. The remote unit includes a lock mechanism. In an embodiment the lock mechanism operated by at least one of: numerical passwords, word passwords, fingerprint recognition, face recognition, eye recognition, and a physical key.

The unmanned aerial vehicle 100 further includes a wireless unit to establish a communication with the remote unit in order to transmit the notification to the one or more authority. The unmanned aerial vehicle 100 further includes a power supply unit to provide a DC power supply to the crisis detection unit. The unmanned aerial vehicle 100 further includes plurality of landing gear to enable the UAV to taking off and landing. The unmanned aerial vehicle 100 further comprising an observing unit to observe one or more weather condition. The unmanned aerial vehicle 100 further includes a solar panel to power the crisis detection unit. The unmanned aerial vehicle 100 further includes a wind turbine unit to power the crisis detection unit.

The unmanned aerial vehicle 100 further includes a rear propeller to enhance the speed of the unmanned aerial vehicle. The unmanned aerial vehicle 100 further includes a measuring unit to measure the distance of the target from the unmanned aerial vehicle. The unmanned aerial vehicle 100 further includes a display unit to display the images being taken by the camera unit. Additionally, the UAV 100 includes a broadcasting unit to transmit the captured data to one or more external devices. Examples of the external device includes but not limited to a display screen, a projector, a split screen, a switch screen, and a headset.

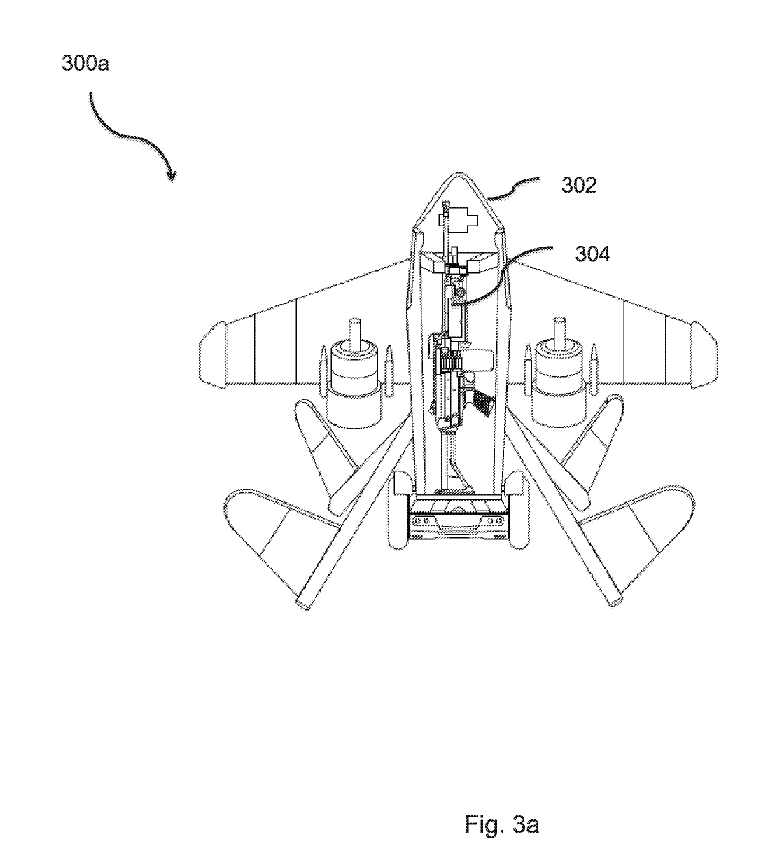

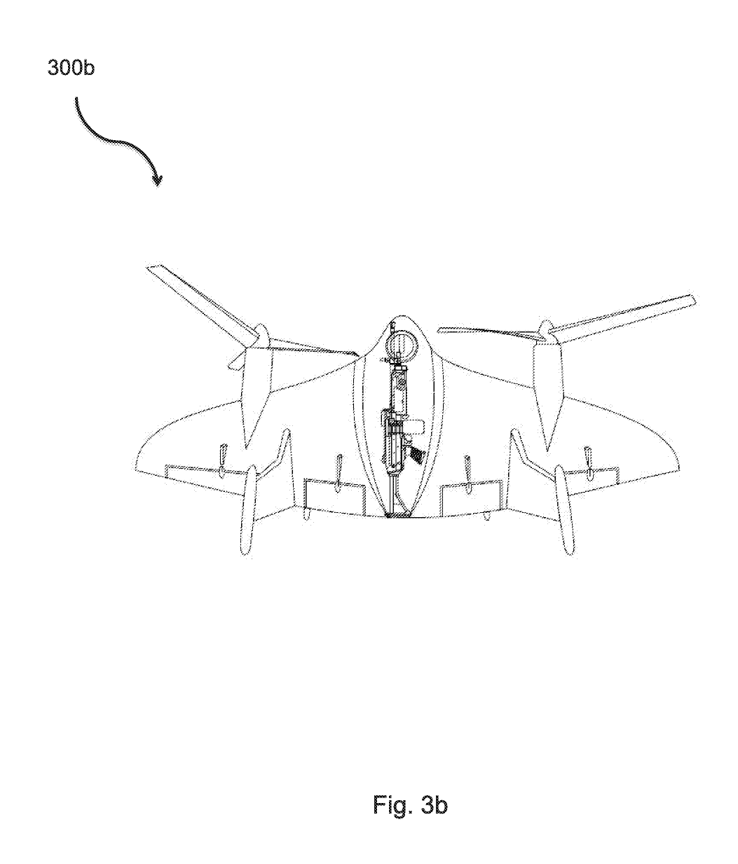

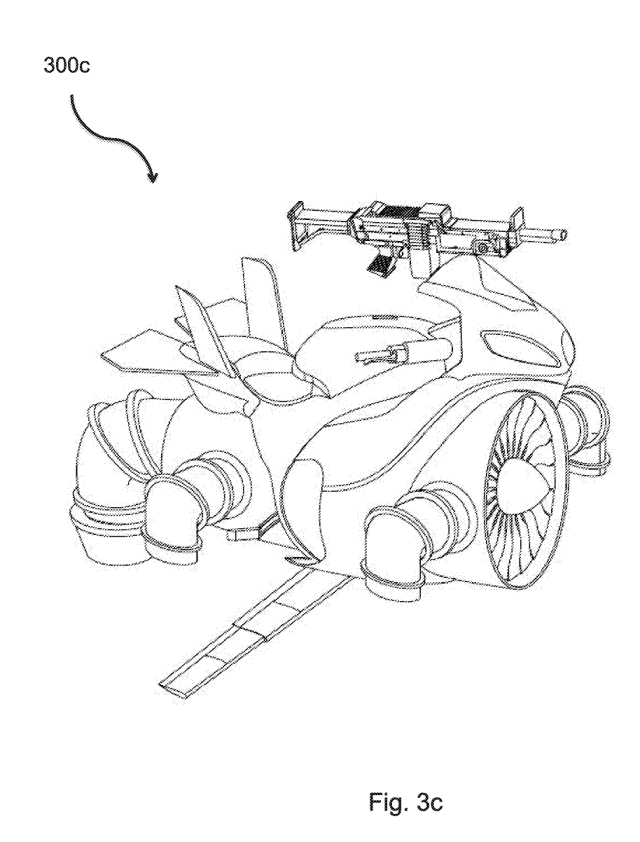

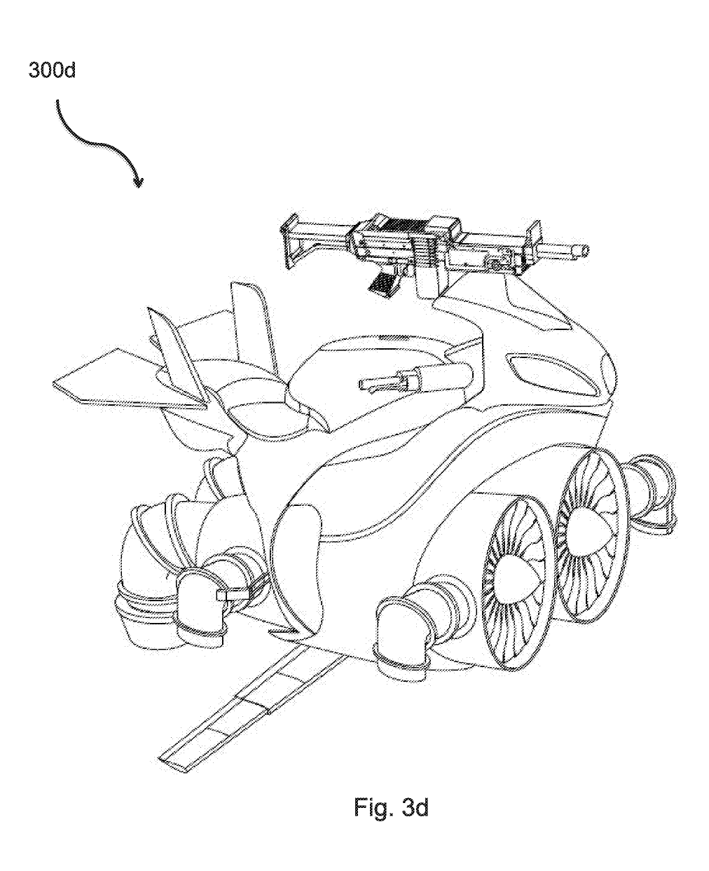

FIGS. 2a-2e are exemplary operational view 200a, 200b, 200c, and 200d of a first unmanned aerial vehicle (UAV) for managing a crisis environment and controlling one or more target, in accordance with at least one embodiment. The first plurality of tranquilizer gun 202a, 202b, and 202c gun to receive the analyzed data from the crisis detection unit and initiates an action in order to sedate one or more target. The plurality of tranquilizer gun 202 filled with at least one of: a sedative chemical; an anesthetic agent; and a paralytic agent. a plurality of rotors, In an embodiment, the present UAV includes a plurality of rotors being operable to tilt on a three axis, the one or more of the plurality of motors is attached to at least one arm, and a mating tilt mechanism to the at least one arm is actuated by one or more motors or a servomotor drive train. FIGS. 3a-3b are illustrating a fuselage 300 having a forward cockpit 302 to house a second plurality of tranquilizer, in accordance with at least one embodiment. FIGS. 3c-3d are exemplary operational views of a second unmanned aerial vehicle (UAV) for managing a crisis environment and controlling one or more target, in accordance with at least one embodiment.

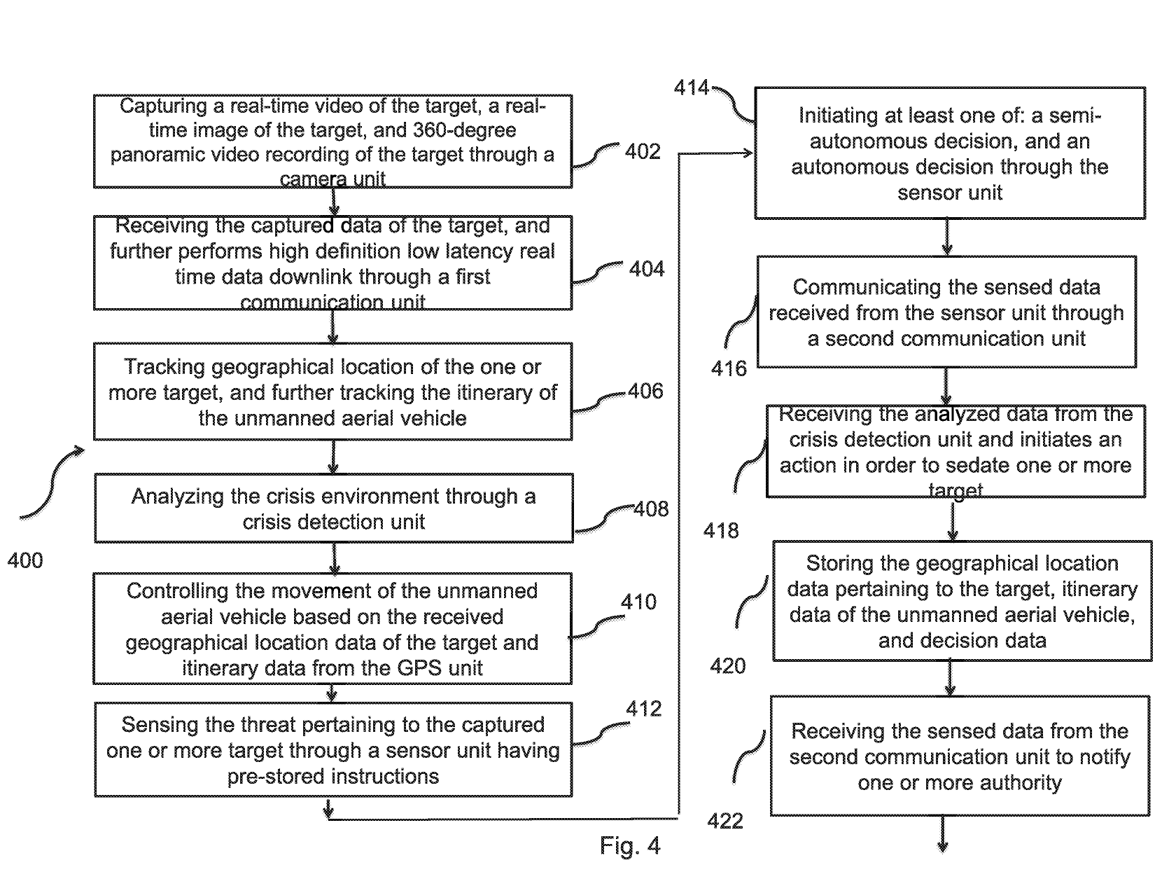

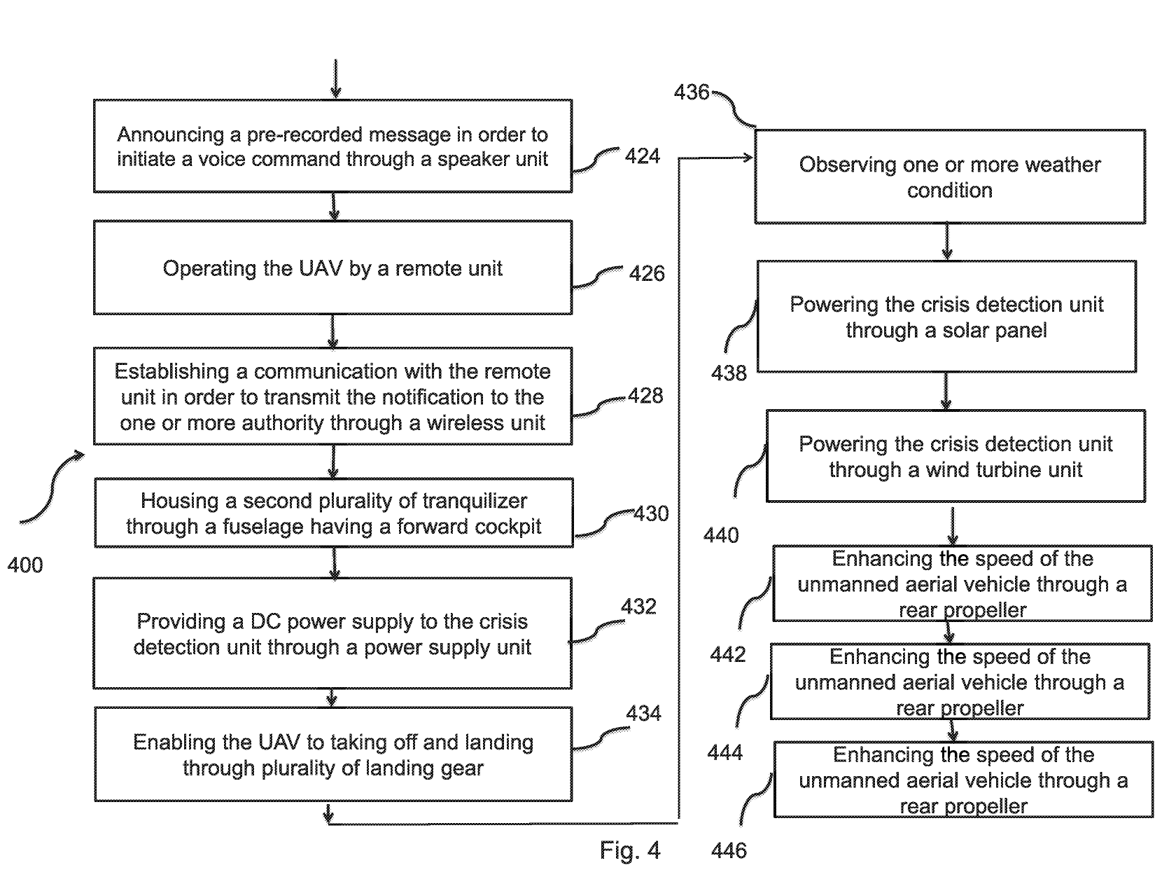

FIG. 4 is a flowchart that illustrates a method 400 for managing a crisis environment and controlling one or more target through an unmanned aerial vehicle (UAV), in accordance with at least one embodiment. The flowchart 400 is described in conjunction with FIG. 1, FIG. 2, and FIG. 3. The method starts at step 402.

At step 402, capturing an image of one or more target through a camera unit. At step 404, receiving the image of the target through a first communication unit integrated with the camera unit. At step 406, tracking geographical location of the one or more target, and further tracking the itinerary of the unmanned aerial vehicle. At step 408, analyzing the crisis environment through a crisis detection unit.

At step 410, controlling the movement of the unmanned aerial vehicle based on the received geographical location data of the target and itinerary data from the GPS unit through a processing unit. At step 412, sensing the threat pertaining to the captured one or more target through a sensor unit having pre-stored instructions.

At step 414, initiating at least one of: a semi-autonomous decision, and an autonomous decision through the sensor unit. At step 416, communicating the sensed data received from the sensor unit through a second communication unit. At step 418, receiving the analyzed data from the crisis detection unit and initiates an action in order to sedate one or more target through a first plurality of tranquilizer gun.

At step 420 storing the geographical location data pertaining to the target, itinerary data of the unmanned aerial vehicle, and decision data through a memory unit. At step 422, receiving the sensed data from the second communication unit to notify one or more authority through a notification unit.

At step 424, announcing a pre-recorded message in order to initiate a voice command through a speaker unit. At step 426, operating the UAV by a remote unit. At step 428, establishing a communication with the remote unit in order to transmit the notification to the one or more authority through a wireless unit.

At step 430, housing a second plurality of tranquilizer through a fuselage having a forward cockpit. At step 432, providing a DC power supply to the crisis detection unit through a power supply unit. At step 434, enabling the UAV to taking off and landing through plurality of landing gear. At step 436, of observing one or more weather condition.

At step 438, powering the crisis detection unit through a solar panel. At step 440, powering the crisis detection unit through a wind turbine unit. At step 442, enhancing the speed of the unmanned aerial vehicle through a rear propeller. At step 444, measuring the distance of the target from the unmanned aerial vehicle through a measuring unit. At step 446, displaying the images being taken by the camera unit through a display unit.

A person skilled in the art will understand that the UAV 100 is described herein for illustrative purposes and should not be construed to limit the scope of the disclosure. Various embodiments of the disclosure encompass numerous advantages including apparatuses, methods and systems for managing a crisis environment and controlling one or more target through an unmanned aerial vehicle (UAV).

A person with ordinary skills in the art will appreciate that the apparatuses, systems, modules, and sub-modules have been illustrated and explained to serve as examples and should not be considered limiting in any manner. It will be further appreciated that the variants of the above disclosed system elements, modules, and other features and functions, or alternatives thereof, may be combined to create other different apparatuses, systems or applications.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while steps are presented in a given order, alternative embodiments may perform routines having steps in a different order. The teachings of the invention provided herein can be applied to other systems, not only the systems described herein. The various embodiments described herein can be combined to provide further embodiments. These and other changes can be made to the invention in light of the detailed description.

All the above references and U.S. patents and applications are incorporated herein by reference. Aspects of the invention can be modified, if necessary, to employ the systems, functions and concepts of the various patents and applications described above to provide yet further embodiments of the invention.

What is claimed is:

1. An amphibious vertical takeoff and landing unmanned device with artificial intelligence (AI) for managing a crisis environment and controlling one or more target, the unmanned aerial vehicle comprising:
a camera unit to capture an image of one or more target;
a first communication unit integrated with the camera unit to receive the image of the target;
a GPS unit configured with the first communication unit to track geographical location of the one or more target, and further tracks the itinerary of the unmanned aerial vehicle;
a crisis detection unit to analyze the crisis environment, the crisis detection unit comprising:
a processing unit to control the movement of the unmanned aerial vehicle based on the received geographical location data of the target and itinerary data from the GPS unit;
a sensor unit having pre-stored instructions to sense the threat pertaining to the captured one or more target, and further the sensor unit programmed in order to initiate at least one of: a semi-autonomous decision, and an autonomous decision; and
a second communication unit to communicate the sensed data received from the sensor unit;
a first plurality of tranquilizer gun to receive the analyzed data from the crisis detection unit and initiates an action in order to sedate one or more target.
a propulsion system including a coaxial propulsion system, wherein the propulsion system comprises a plurality of motors and rotors associated with the plurality of motors, wherein the rotors are selected from a group comprising: clockwise rotors, counterclockwise rotors, and variable pitch rotors;
a rotor protection system; at least one wing; a landing system that conforms to a landing surface, the landing system including at least a chassis; one or more control surfaces selected from a group comprising: a rudder, an aileron, a flap, and an elevator; an onboard air compressor; an onboard electrolysis system; at least one waterproof through-body wire or antenna feed-through; a tilt wing device; a door connected to the modular and expandable waterproof body, wherein the door is selected from a group comprising: a gull wing door and a falcon wing door; at least one tilt rotor device;
a power distribution board comprising one or more of the following: a flight controller, electronic speed controllers, a buzzer, an on screen display telemetry device, a video transmitter, and a radio control receiver; wherein the rotors include at least a first rotor and a second rotor, the first rotor being operable to rotate about a first axis and tilt about a second axis between a helicopter mode and an aeroplane mode, wherein the first rotor comprises a shaft operable to rotate about the first axis and tilt about the second axis between the helicopter mode and the aeroplane mode; the first axis being transversal to a longitudinal direction of the amphibious VTOL unmanned device in the helicopter mode and being substantially parallel to the longitudinal direction in the aeroplane mode, and the second rotor being operatively connected to the shaft of the first rotor;an electrical power storage device, wherein the electrical power storage device includes at least a battery, wherein a shape of the battery conforms to an interior profile of the modular and expandable waterproof body;
an electrical machine comprising a stator and an onboard electricity generator, the stator being electrically connected to the electrical power storage device, wherein the onboard electricity generator is selected from a group comprising: a plurality of solar cells, one or more wind turbines, and one or more hydroelectric generators; wherein the electrical machine acts as an electric motor for driving rotation of the first rotor by using the electrical power storage device, and wherein the electrical machine acts as an electrical power generator for re-charging the electrical power storage device by causing the rotation of the second rotor under action of a wind current; wherein the plurality of motors includes at least a solar turbine powered impeller motor, the solar turbine powered impeller motor being disposed centrally in the amphibious VTOL unmanned device, the solar turbine powered impeller motor comprising an electric-drive impeller contained in a compression chamber and having an axis of rotation oriented perpendicularly to an axis of the amphibious VTOL unmanned device, the solar turbine powered impeller motor being powered by the plurality of solar cells when the plurality of solar cells is used, the plurality of solar cells comprising at least a solar film, the solar film being integrated on one or more of the following: an upper surface of the amphibious VTOL unmanned device; and
a lidar; and an ultrasonic radar sensor; wherein the at least one wing includes a left forward swept wing and a right forward swept wing, the left forward swept wing and the right forward swept wing being mounted on the chassis, and wherein the rotors further include a first brushless ducted fan and a second brushless ducted fan integrated left and right of the chassis, the first brushless ducted fan and the second brushless ducted fan being powered by the solar film, the first brushless ducted fan and the second brushless ducted fan being associated with a brushless electric motor operable to spin the electric-drive impeller to provide at least one air accelerator ring with compressed forced air thrust.

2. The unmanned aerial vehicle according to claim 1 further including a memory unit to store the geographical location data pertaining to the target, itinerary data of the unmanned aerial vehicle, and decision data, wherein the modular and expandable waterproof body has a back portion and a front portion, wherein the amphibious VTOL unmanned device is configured to be launched from a body of a user, wherein the amphibious VTOL unmanned device is operable to perform an automatic landing and an automatic takeoff, wherein the amphibious VTOL unmanned device is configured in a form of one of the following: a people-carrying vehicle, a cargo-carrying vehicle, a radio controlled toy, an autonomous vehicle, a multi-blade ducted fan roadable electric aircraft, an uncrewed vehicle, a driverless car, a self-driving car, an unmanned aerial vehicle, a drone, a robotic car, a commercial goods and passenger carrying vehicle, and a private self-drive vehicle; wherein the autonomous vehicle is configured to sense environmental conditions, navigate without human input, and perform autopiloting; wherein the sensing is performed via one or more of the following: the ultrasonic radar sensor, the lidar, the GPS module, and a computer vision module; wherein the environmental sample processor is operable to interpret sensory information to identify navigation paths, obstacles and signage; wherein the autonomous vehicle is operable to update maps based on sensory input to keep track of a position when conditions change or when uncharted environments are entered; and wherein the multi-blade ducted fan roadable electric aircraft is propelled by the plurality of motors using electrical energy stored in the electrical power storage device.

3. The unmanned aerial vehicle according to claim 1 further including a notification unit to receive the sensed data from the second communication unit to notify one or more authority.

4. The unmanned aerial vehicle according to claim 1 further including a speaker unit to announce a pre-recorded message in order to initiate a voice command.

5. The plurality of tranquilizer gun according to claim 1 filled with at least one of: a sedative chemical; an anesthetic agent; and a paralytic agent.

6. The unmanned aerial vehicle according to claim 1 is operated by a remote unit, further establishing a communication with the remote unit in order to transmit the notification to the one or more authority through a wireless unit.

7. The unmanned aerial vehicle according to claim 1 further includes a wireless unit to establish a communication with the remote unit in order to transmit the notification to the one or more authority.

8. The unmanned aerial vehicle according to claim 1 further includes a fuselage having a forward cockpit to house a second plurality of tranquilizer, further includes the step of housing a second plurality of tranquilizer through a fuselage having a forward cockpit,wherein the modular and expandable waterproof body has a back portion and a front portion, wherein the amphibious VTOL unmanned device is configured to be launched from a body of a user, wherein the amphibious VTOL unmanned device is operable to perform an automatic landing and an automatic takeoff, wherein the amphibious VTOL unmanned device is configured in a form of one of the following: a people-carrying vehicle, a cargo-carrying vehicle, a radio controlled toy, an autonomous vehicle, a multi-blade ducted fan roadable electric aircraft, an uncrewed vehicle, a driverless car, a self-driving car, an unmanned aerial vehicle, a drone, a robotic car, a commercial goods and passenger carrying vehicle, and a private self-drive vehicle; wherein the autonomous vehicle is configured to sense environmental conditions, navigate without human input, and perform autopiloting; wherein the sensing is performed via one or more of the following: the ultrasonic radar sensor, the lidar, the GPS module, and a computer vision module; wherein the environmental sample processor is operable to interpret sensory information to identify navigation paths, obstacles and signage; wherein the autonomous vehicle is operable to update maps based on sensory input to keep track of a position when conditions change or when uncharted environments are entered; and wherein the multi-blade ducted fan roadable electric aircraft is propelled by the plurality of motors using electrical energy stored in the electrical power storage device.

9. The unmanned aerial vehicle according to claim 1 further comprising a power supply unit to provide a DC power supply to the crisis detection unit.

10. The unmanned aerial vehicle according to claim 1 further comprising plurality of landing gear to enable the UAV to taking off and landing, further includes the step of observing one or more weather condition.

11. The unmanned aerial vehicle according to claim 1 further comprising an observing unit to observe one or more weather condition.

12. The unmanned aerial vehicle according to claim 1 further comprising a solar panel to power the crisis detection unit, further includes the step of enabling the UAV to taking off and landing through plurality of landing gear.

13. The unmanned aerial vehicle according to claim 1 further comprising a wind turbine unit to power the crisis detection unit.

14. The unmanned aerial vehicle according to claim 1 further comprising a rear propeller to enhance the speed of the unmanned aerial vehicle.

15. The unmanned aerial vehicle according to claim 1 further comprising a measuring unit to measure the distance of the target from the unmanned aerial vehicle.

16. The unmanned aerial vehicle according to claim 1 further comprising a display unit to display the images being taken by the camera unit, further includes the step of measuring the distance of the target from the unmanned aerial vehicle through a measuring unit.

17. An amphibious vertical takeoff and landing unmanned device with artificial intelligence (AI) method for managing a crisis environment and controlling one or more target through an unmanned aerial vehicle (UAV), the method comprising the steps of:
capturing an image of one or more target through a camera unit;
receiving the image of the target through a first communication unit integrated with the camera unit;
tracking geographical location of the one or more target, and further tracking the itinerary of the unmanned aerial vehicle through a GPS unit configured with the first communication unit;
analyzing the crisis environment through a crisis detection unit;
controlling the movement of the unmanned aerial vehicle based on the received geographical location data of the target and itinerary data from the GPS unit through a processing unit;
sensing the threat pertaining to the captured one or more target through a sensor unit having pre-stored instructions;
initiating at least one of: a semi-autonomous decision, and an autonomous decision through the sensor unit;
communicating the sensed data received from the sensor unit through a second communication unit; and
receiving the analyzed data from the crisis detection unit and initiates an action in order to sedate one or more target through a first plurality of tranquilizer gun, further includes the step of providing a DC power supply to the crisis detection unit through a power supply unit, further includes the step of powering the crisis detection unit through a solar panel, further includes the step of powering the crisis detection unit through a wind turbine unit. further includes the step of display the images being taken by the camera unit through a display unit.

18. The method according to claim 17 further includes the step of storing the geographical location data pertaining to the target, itinerary data of the unmanned aerial vehicle, and decision data through a memory unit;

19. The method according to claim 17 further includes the step of receiving the sensed data from the second communication unit to notify one or more authority through a notification unit.

20. The method according to claim 17 further includes the step of announcing a pre-recorded message in order to initiate a voice command through a speaker unit.
